(19) United States
(12) Patent Application Publication
(10) Pub. No.: US 2010/0192100 A1
(43) Pub. Date: Jul. 29, 2010

(54) Method for operating a space menu and electronic device with operating space menu

(75) Inventors: Yi-hsi Wu, Taipei City (TW); Ching Chih Chang, Taipei City (TW)

Correspondence Address: J C PATENTS, 4 VENTURE, SUITE 250, IRVINE, CA, 92618, US

(73) Assignee: COMPAL ELECTRONICS, INC., Taipei City (TW)

(21) Appl. No.: 12/321,637

(22) Filed: Jan. 23, 2009

(51) Int. Cl. G06F 3/048

(52) U.S. Cl. 715/834; 715/821

(57) ABSTRACT

A method for operating a space menu, suitable for an electronic device having a screen is provided. In the present method, a plurality of item objects are sequentially displayed along a linear path on a menu plane to generate a space menu. Then, an operation of a user for the space menu is received and used for operating the space menu. The item objects on the menu plane are rotated about a rotation axis according to a position of the item object pointed by the operation so as to protrude the pointed item object from the other item objects, in which a direction of the rotation axis is not parallel to a normal direction of a display plane of the screen. Further, an item function is executed according to the item object selected by the operation.

### BACKGROUND OF THE INVENTION

1. Field of the Invention

The present invention generally relates to a method for operating a user interface and an electronic device with the user interface, and more particularly, to a method for operating a space menu and an electronic device with the space menu.

2. Description of Related Art

In order to catch up with the quick pace of the modern life, various portable electronic devices that can be conveniently taken along without occupying a large space have been increasingly developed. The portable electronic device not only provides various functions of a conventional communication device, but also enables a user to write a document, send/receive E-mails, browse websites, or use instant messaging software through a built-in windows operation system. With the rapid progress of the wireless network technique, the applications of such functions are no longer limited by time and space. For the modern people who stress on efficiency, such communication device has become one of the indispensable tools.

As the functions applied to the electronic device increases, various means for operating the electronic deivce to execute functions have been developed. One of them is to display a menu containing a plurality of options, each of which corresponds to one of the functions provided by the electronic device. The user may control the electronic deivce to display sub menus or execute functions by simply clicking one of the options in the menu.

For example, U.S. Pat. No. 6,211,921 B1 disclosed an user interface for television, in which a rotating menu including some options is provided. FIG. 1 shows a television screen displaying a menu. Referring to FIG. 1, the menu is a sort of carousel which rotates on the screen. The menu is displayed in a perspective which creates an apparent plane of rotation of the menu, in which the apparent plane of rotation is not parallel to the face of the screen. The options are rotated according to a control from a user and a highlighted option is appearred in front so as to enable the user to find or execute desired function more easily.

The conventional menu allows the user to rotate the options so as to select the one desired to run. However, for those options originally appearred in the back of the menu, the user has to rotate the menu by pressing a left or a right key for many times until the desired option is rotated to the front, such that the icon representing the option can be displayed for the user to browse, which is very inconvenient. Accordingly, a more intuitive way for a user to operate the menu or search for the option to be executed is needed.

### SUMMARY OF THE INVENTION

In light of the above, the present invention provides a method for operating a space menu, in which the space menu containing a plurality of item objects are displayed on a screen and rotated according to the position pointed by a user, so as to provide a more intuitive and quick way for operating functions of an electronic device.

The present invention provides an electronic device with an operating space menu, in which the space menu containing a plurality of item objects are arranged sequentially along a spiral path on a menu plane and rotated according to the position pointed by a user, so as to provide a more intuitive and quick way for operating functions of an electronic device.

In order to achieve the above-mentioned or other objects, the present invention provides a method for operating a space menu, which is suitable for an electronic device having a screen. In the present method, a plurality of item objects are sequentially displayed along a linear path on a menu plane to generate a space menu. Then, an operation of a user for the space menu is received and used for operating the space menu. The item objects on the menu plane are rotated about a rotation axis according to a position of the item object pointed by the operation so as to protrude the pointed item object from the other item objects, in which a direction of the rotation axis is not parallel to a normal direction of a display plane of the screen. Further, an item function is executed according to the item object selected by the operation.

According to an embodiment of the present invention, the operation of the user for the space menu comprises using an input device to move around the space menu or select one of the item objects. The input device comprises mouse, keyboard, touch panel, or touch screen.

According to an embodiment of the present invention, the direction of the axis is perpendicular to a direction of the linear path.

According to an embodiment of the present invention, in the step of rotating the item objects on the menu plane about the rotation axis according to the position of the item object pointed by the operation, a rotation angle for rotating the menu plane is calculated according to a distance between the pointed item object and the rotation axis, whether to rotate the menu plane in a clockwise direction or in a counter clockwise direction is then determined according to a relative position of the pointed item object corresponding to the rotation axis, and finally the item objects on the menu plane are rotated about the rotation axis to the determined direction by the rotation angle.

According to an embodiment of the present invention, the step of rotating the item objects on the menu plane about the rotation axis according to the position of the item object pointed by the operation further comprises zooming the item objects on the menu plane so as to be covered by display plane of the screen according to the rotation angle and the relative position and distance between each of the item objects and the axis. The rotation axis comprises passing through a geometric center of the item objects.

According to an embodiment of the present invention, after the step of rotating the item objects on the menu plane about the rotation axis according to the position of the item object pointed by the operation, the method further comprises enlarging the item object pointed by the operation so as to protrude the pointed item object from the other item objects.

According to an embodiment of the present invention, after the step of rotating the item objects on the menu plane about the rotation axis according to the position of the item object pointed by the operation, the method further comprises moving the item object pointed by the operation toward a normal direction of the menu plane by a preset length so as to protrude the pointed item object from the other item objects.

According to an embodiment of the present invention, the step of sequentially displaying the item objects along a linear path on the menu plane further comprises displaying an item icon on a surface of each item object facing a normal direction of the menu plane.

The present invention provides a method for operating a space menu, suitable for an electronic device having a screen. In the present method, a plurality of item objects are sequentially displayed along a spiral path to generate a space menu, in which a central axis of the spiral path is not parallel to a normal direction of a display plane of the screen. Then, an operation of a user for the space menu is received, in which the item objects on the spiral path are rotated about the central axis according to a position of the item object pointed by the operation so as to protrude the pointed item object from the other item objects, and an item function is executed according to the item object selected by the operation.

According to an embodiment of the present invention, the step of sequentially displaying the item objects along the spiral path to generate the space menu comprises zooming the item objects according to a relative distance between each of the item objects and the display plane of the screen.

According to an embodiment of the present invention, the step of rotating the item objects on the spiral path about the central axis according to the position of the item object pointed by the operation so as to protrude the pointed item object from the other item objects comprises rotating the item objects on the spiral path about the central axis such that the relative distance between the pointed item object and the display plane of the screen is the shortest.

According to an embodiment of the present invention, the operation of the user for the space menu comprises using an input device to move around the space menu or select one of the item objects. The input device comprises mouse, keyboard, touch panel, or touch screen.

According to an embodiment of the present invention, a position of each item object projected on the central axis remains unchanged when the item objects on the spiral path are rotated about the central axis.

According to an embodiment of the present invention, in the step of rotating the item objects on the spiral path about the central axis according to the position of the item object pointed by the operation, a rotation angle for rotating the item objects on the spiral path is calculated according to the relative distance between the pointed item object and the display plane of the screen, whether to rotate the item objects on the spiral path in a clockwise direction or in a counter clockwise direction is determined according to a relative position of the pointed item object on the central axis, and finally the item objects on the spiral path are rotated about the central axis to the determined direction by the rotation angle.

According to an embodiment of the present invention, the step of rotating the item objects on the spiral path about the central axis according to a position of the item object pointed by the operation further comprises zooming the item objects according to a relative distance between each of the item objects and the display plane of the screen after the item objects are rotated.

According to an embodiment of the present invention, after the step of rotating the item objects on the spiral path about the central axis according to a position of the item object pointed by the operation, the method further comprises enlarging the item object pointed by the operation so as to protrude the pointed item object from the other item objects.

According to an embodiment of the present invention, the step of sequentially displaying the item objects along the spiral path to generate the space menu comprises displaying an item icon on a surface of each item object facing a normal direction from the central axis of the spiral path to the item object.

According to an embodiment of the present invention, the item objects comprises two-dimensional objects or three-dimensional objects, and the item function comprises multimedia playback, calendar, internet, electronic mail, phone, game or system setting.

The present invention provides an electronic device with an operating space menu, in which the electronic device comprises a screen, a space menu, and an input signal receiving module. The space menu comprises a plurality of item objects and is displayed on said screen, wherein said plurality of item objects are arranged sequentially along a linear path on a menu plane. The input signal receiving module receives an operation of a user for the space menu, wherein the item objects are rotated on the menu plane about a rotation axis according to a position of the item object pointed by the operation and a direction of the rotation axis is not parallel to a normal direction of a display plane of the screen.

The present invention provides an electronic device with an operating space menu, in which the electronic device comprises a screen, a space menu, and an input signal receiving module. The space menu comprises a plurality of item objects and being displayed on said screen, wherein said plurality of item objects are arranged sequentially along a spiral path on a menu plane. The input signal receiving module receives an operation of a user for the space menu, wherein the item objects are rotated on the spiral path about the central axis according to a position of the item object pointed by the operation and a central axis of the spiral path is not parallel to a normal direction of a display plane of the screen.

In the present invention, a plurality of item objects are sequentially arranged along a linear path on a menu plane or sequentially arranged along a spiral path with a central axis not parallel to a normal direction of the display plane. The space menu is rotated according to the position pointed by an operation of a user, so as to protrude the item object desired to run from all the other item objects. Accordingly, a more intuitive way for operating a menu is provided.

In order to make the aforementioned and other objects, features, and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a television screen displaying a menu.

FIG. 2 is a flowchart illustrating a method for operating a space menu according to one embodiment of the present invention.

FIG. 3 is an example of a space menu according to one embodiment of the present invention.

FIGS. 4A, 4B, and 4C are examples illustrating a method for operating a space menu according to one embodiment of the present invention.

FIG. 5 is a flowchart illustrating a method for operating a space menu according to one embodiment of the present invention.

FIG. 6 is an example of a space menu according to one embodiment of the present invention.

FIGS. 7A, 7B, and 7C are examples illustrating a method for operating a space menu according to one embodiment of the present invention.

FIG. 8 is a block diagram illustrating an electronic device with an operating space menu according to one embodiment of the present invention.

FIG. 9 is a block diagram illustrating an electronic device with an operating space menu according to one embodiment of the present invention.

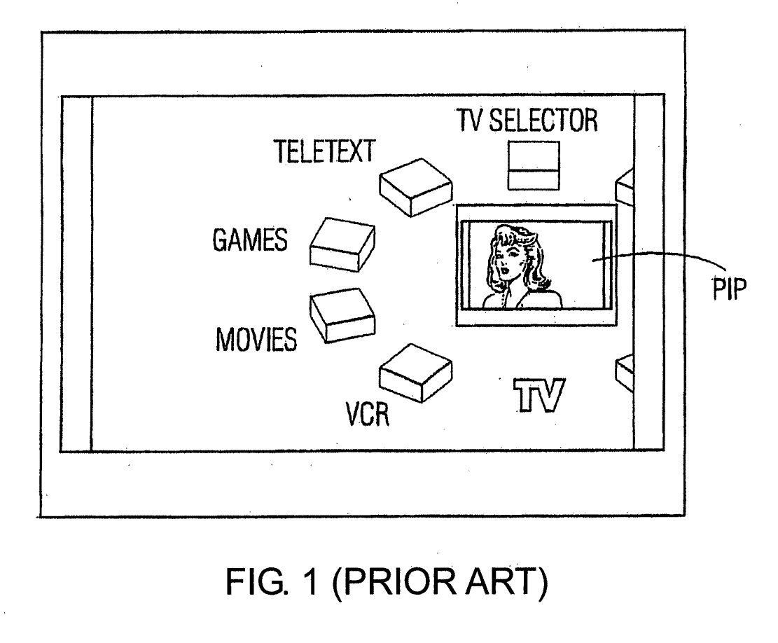

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Within a limited display area of a screen, to correspond each item object of a space menu with a specific operation, the present invention defines a specific area of the display plane for each of the item objects. When a cursor controlled by a user or a touch from the user is detected to be moved on one of the specific areas, the item object corresponded thereto is recognized and the space menu is rotated appropriately so as to protrude the desired item object from the other item objects in the space menu. Accordingly, a user may select any item object in the space menu by simply moving a cursor to the specific area or directly touching the specific area, and then the desired item object is moved to the front and the function thereof is executed. According to the above, the present invention provides a method for operating a space menu. To make the content of the present invention more comprehensive, some embodiments are provided in the following as examples for the implementation of the present invention.

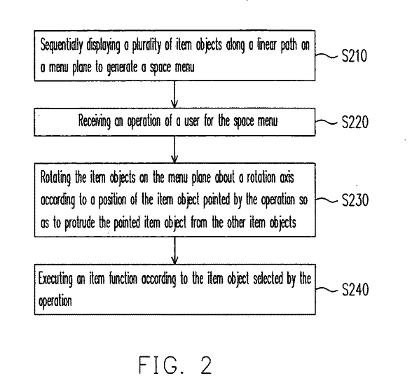

FIG. 2 is a flowchart illustrating a method for operating a space menu according to one embodiment of the present invention. Referring to FIG. 2, the space menu is displayed on a screen of an electronic device, in which the electronic device may be a mobile phone, a personal digital assistant (PDA), or a laptop, but the scope of the present invention is not limited thereto. The method includes the following steps.

First, a plurality of item objects are sequentially displayed along a linear path on a menu plane, so as to generate a space menu (step S210), in which the menu plane may not be parallel to the display plane so that the item objects are visually arranged in a three-dimensional space instead of being arranged on a two-dimensional display plane. Further, an item icon is displayed on a surface of each item object facing a normal direction of the menu plane, so as to represent a function corresponding to the item object. However, besides being displayed by three-dimensional objects such as balls or cubes, the item objects may be displayed by two-dimensional objects such as cards or photos, and the item icons are displayed on one side of the item objects.

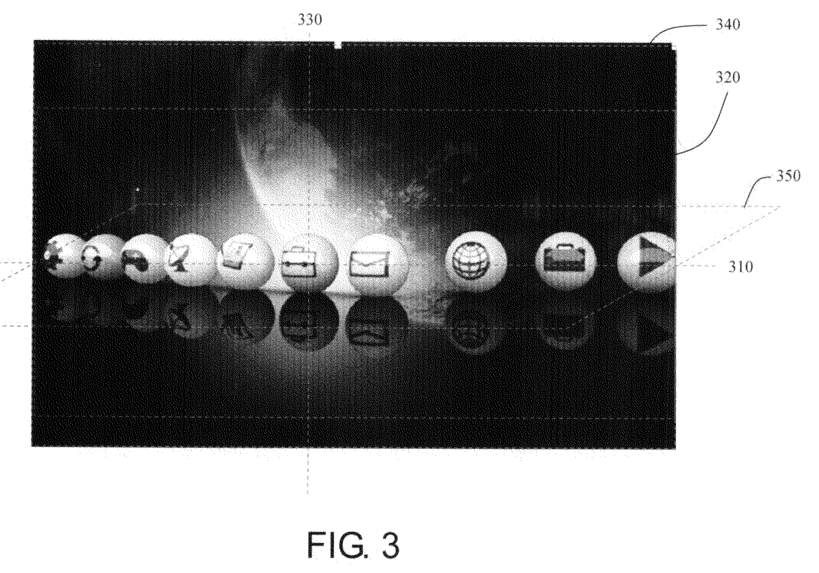

For example, FIG. 3 is an example of a space menu according to one embodiment of the present invention. Referring to FIG. 3, a plurality of item balls are aligned and placed along a line path 310 on a menu plane 320 so as to form a space menu, and further, the item balls are rotated about a rotation axis 330 along with the menu plane 320 according to an operation of a user, in which the menu plane 320 is parallel to the display plane 340 of the screen but perpendicular to a ground plane 350. Item icons representing item functions such as multimedia playback, business, internet, electronic mail, office, calendar, GPS, game, return and tools are displayed on a surface of each item ball facing a normal direction of the menu plane 320, so as to represent a function corresponding to the item ball. Moreover, the size of the item ball is gradually magnified as the item ball is placed closer to the display plane 340, such that the item ball the user is interested in can be protruded from the other item balls.

Next, an operation of a user for the space menu is received (step S220). The operation for the space menu can be detected when a user uses an input device to move around the space menu or select one of the item objects. For example, the user may use a mouse, a keyboard, or a touch panel for controlling a cursor on the screen of the electronic device. When the cursor is moved around the space menu and passed by an item object, the operation of the user is interpreted as a pointing operation. When the cursor is moved on the item object and a selection key (e.g. left key of the mouse) is pressed, the operation of the user is interpreted as a selecting operation. On the other hand, if the electronic device is equipped with a touch screen, the user may simply touch and drag on the screen to operate the space menu. Similarly, when the touch is dragged around the space menu and passed by an item object, the operation of the user is interpreted as a pointing operation. When the touch is performed right on the item object, the operation of the user is interpreted as a selecting operation.

According to the above, if the operation of the user is interpreted as a pointing operation, the menu plane is rotated about a rotation axis according to a position of the item object pointed by the operation so as to protrude the pointed item object from the other item objects (S230), in which the rotation axis may pass through a geometric center of the item objects and a direction thereof is not parallel to a normal direction of a display plane of the screen.

In detail, according to a distance between the pointed item object and the rotation axis, a rotation angle for rotating the menu plane is calculated, in which the rotation angle may be proportioned to the distance. Further, according to a relative position of the pointed item object corresponding to the rotation axis, whether to rotate the menu plane in a clockwise direction or in a counter clockwise direction can also be determined. For example, if the pointed item object is on the right side of the axis, the menu plane is rotated in a clockwise direction, and if the pointed item object is on the left side of the axis, the menu plane is rotated in a counter clockwise direction. Finally, the item objects on the menu plane are rotated in the determined direction by the calculated rotation angle, so as to protrude the pointed item object from the other item objects.

It should be noted herein that, in order to distinctly protrude the item object from the others, whenever the item objects on the menu plane are rotated, the electronic device further enlarges the item object pointed by the operation. In another embodiment, the electronic device may also move the item object pointed by the operation toward a normal direction of the menu plane by a preset length so as to protrude the pointed item object from the other item objects. However, in order to keep all the moved or magnified item objects inside the display plane of the screen, the item objects on the menu plane may be appropriately zoomed so as to be covered by the display plane of the screen according to the rotation angle and the relative position and distance between each of the item objects and the rotation axis.

On the other hand, if the operation of the user is interpreted as a selecting operation, an item function corresponding to the item object selected by the operation is executed (S240). The item function may be multimedia playback, calendar, internet, electronic mail, phone, game or system setting, but the scope of the present invention is not limited thereto.

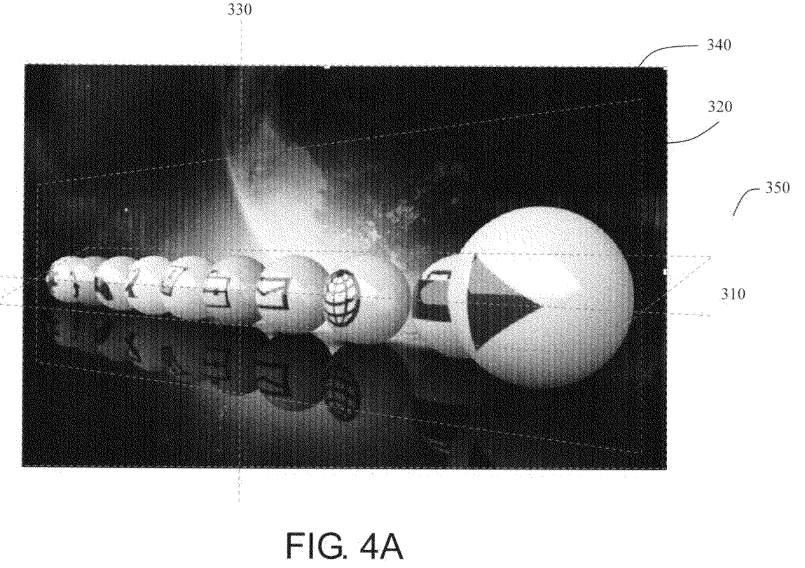

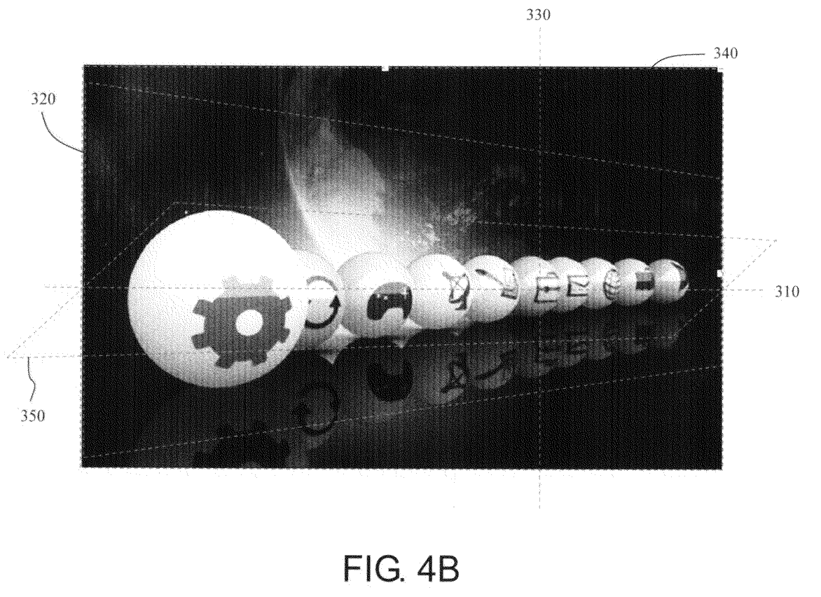

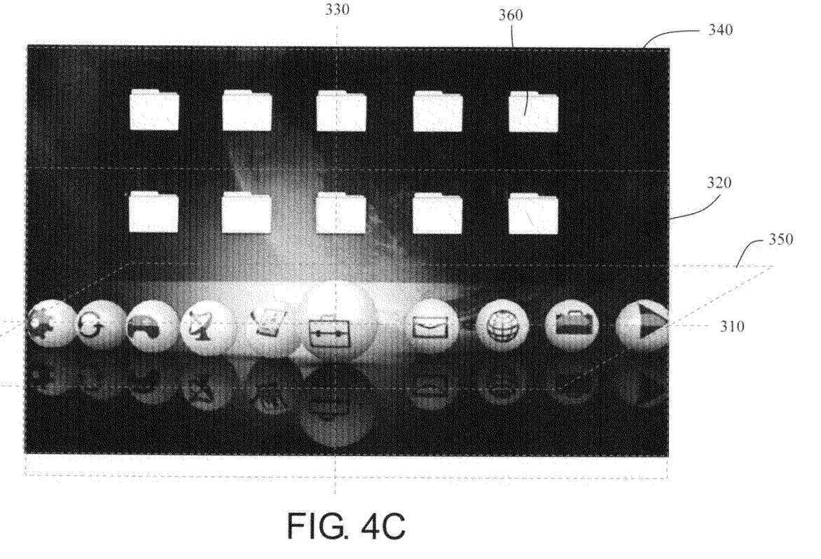

For example, FIGS. 4A, 4B, and 4C are examples illustrating a method for operating a space menu according to one embodiment of the present invention. Referring to FIG. 3 first, the item balls respectively representing functions, from right to left, of multimedia playback, office, internet, electronic mail, business, calendar, GPS, game, return and tools are displayed on a menu plane 320, in which the menu plane 320 is parallel to the display plane 340 of the screen but perpendicular to a ground plane 350.

Referring to FIG. 4A, when a user touches on the space menu and drags through the item ball that represents the multimedia playback function, the menu plane 320 is rotated in a clockwise direction by a rotation angle, in which the rotation angle is proportioned to the distance between the pointed item ball and the axis. As shown in FIG. 4A, after the menu plane 320 is rotated, the designated item ball is enlarged and moved toward a normal direction of the menu plane 320 by a preset length such that it can be protruded from the other item balls.

On the other hand, referring to FIG. 4B, when the user touches on the space menu and drags through the item ball that represents the tools function, the menu plane 320 is rotated in a counterclockwise direction by a rotation angle, in which the rotation angle is proportioned to the distance between the item ball and the axis. Similarly, after the menu plane 320 is rotated, the designated item ball is enlarged and moved toward a normal direction of the menu plane 320 by a preset length such that it can be protruded from the other item balls.

Moreover, referring to FIG. 4C, when the user directly touches on the item ball that represents the business function, since the designated item ball is right on the center of the space menu, the menu plane 320 is not rotated. However, the designated item ball is still enlarged and moved toward a normal direction of the menu plane 320 by a preset length. Meanwhile, the business function is executed and a plurality of business files 340 are displayed above the space menu such that the user can browse and manage those business files.

According to the above method, the present invention provides an intuitive space menu for the user to browse and select item objects. Since each of the item objects are corresponding to a specific area, the user may simply drag through or directly touch the specific area to operate the space menu. Therefore, the redundant operation is reduced and the convenience is increased.

In addition to the aforesaid line arrangement, the present invention further provides another space menu including item objects arranged along a spiral path. Similar operating method may be applied to this space menu so as to provide user with intuitive way to browse and select item objects. Embodiments are given below for detailed illustration.

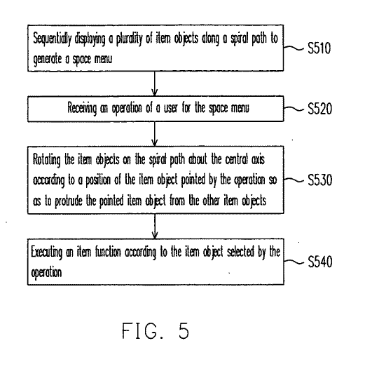

FIG. 5 is a flowchart illustrating a method for operating a space menu according to one embodiment of the present invention. Referring to FIG. 5, the space menu 500 is displayed on a screen of an electronic device, in which the electronic device may be a mobile phone, a personal digital assistant, or a laptop, but the scope of the present invention is not limited thereto. The method includes the following steps.

First, a plurality of item objects are sequentially displayed along a spiral path, so as to generate a space menu (step S510), in which a central axis of the spiral path is not parallel to a normal direction of a display plane of the screen. As being placed on a three-dimensional spiral path, the item objects are visually arranged in a three-dimensional space instead of being arranged on a two-dimensional display plane. Further, an item icon is displayed on a surface of each item object facing a normal direction from the central axis of the spiral path to the item object, so as to represent a function corresponding to the item object. However, besides being displayed by three-dimensional objects, the item objects may be displayed by two-dimensional objects, and the item icons are displayed on one side of the item objects.

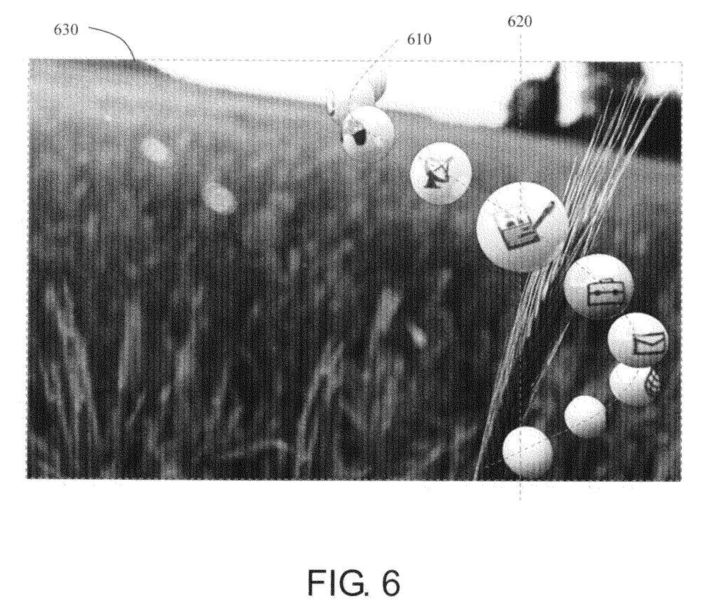

For example, FIG. 6 is an example of a space menu according to one embodiment of the present invention. Referring to FIG. 6, a plurality of item balls are placed along a spiral path 610 whose central axis 620 is perpendicular to the normal direction of a display plane 630 of the screen, so as to form a space menu, and further, the item balls are rotated about the central axis 620 according to an operation of a user. During the rotation of the space menu, the item balls are zoomed according to a relative distance between each of the item balls and the display plane of the screen, such that the item ball having the shortest relative distance from the display plane of the screen is magnified to be the largest one. In addition, item icons representing item functions such as multimedia playback, business, internet, electronic mail, office, calendar, GPS, game, return and tools are displayed on a surface of each item ball facing a normal direction from the central axis of the spiral path to the item ball, so as to represent a function corresponding to the item ball.

Next, an operation of a user for the space menu is received (step S520). The operation for the space menu can be detected as a user uses an input device to move around the space menu or select one of the item objects. The operations of the user can be classified into pointing operations and selecting operations, which is described in the foregoing embodiment such that the detail is omitted herein.

If the operation of the user is interpreted as a pointing operation, the item objects on the spiral path are rotated about the central axis according to a position of the item object pointed by the operation so as to protrude the pointed item object from the other item objects (S530). To be specific, the item objects on the spiral path are rotated about the central axis such that the relative distance between the pointed item object and the display plane of the screen is the shortest. It should be noted herein that a position of each item object projected on the central axis remains unchanged when the item objects on the spiral path are rotated about the central axis.

In detail, according to a relative distance between the pointed item object and the display plane of the screen, a rotation angle for rotating the item objects on the spiral path is calculated. Further, according to a relative position of the pointed item object on the spiral path, whether to rotate the item objects on the spiral path in a clockwise direction or in a counter clockwise direction can also be determined. For example, if the pointed item object is above the geometric center of the space menu, the item objects are rotated in a counter clockwise direction, and if the pointed item object is under the geometric center of the space menu, the menu plane is rotated in a clockwise direction. Accordingly, the item objects on the spiral path are rotated about the central axis in the determined direction by the calculated rotation angle, so as to protrude the pointed item object from the other item objects.

It should be noted herein that, in order to distinctly protrude the item object from the others, whenever the item objects are rotated, the electronic device further enlarges the item object pointed by the operation. Accordingly, the designated item object is rotated to the front and magnified appropriately such that the user may clearly browse the item objects and select the desired one.

On the other hand, if the operation of the user is interpreted as a selecting operation, an item function is executed according to the item object selected by the operation (S540). The item function may be multimedia playback, calendar, internet, electronic mail, phone, game or system setting, but the scope of the present invention is not limited thereto.

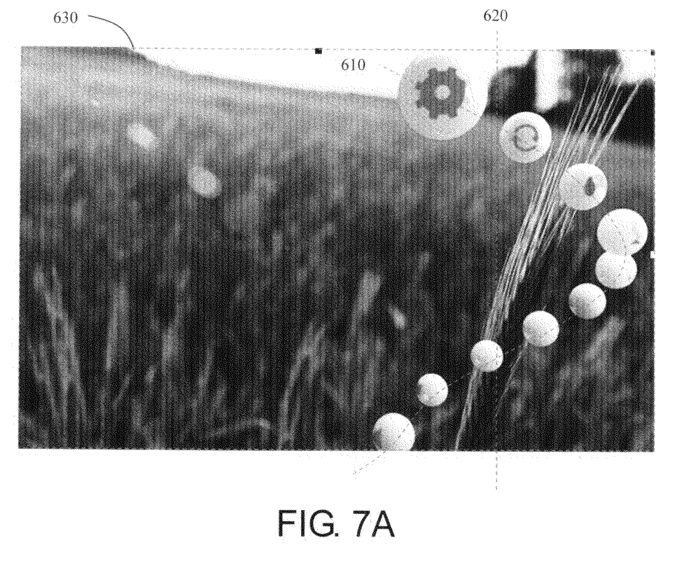

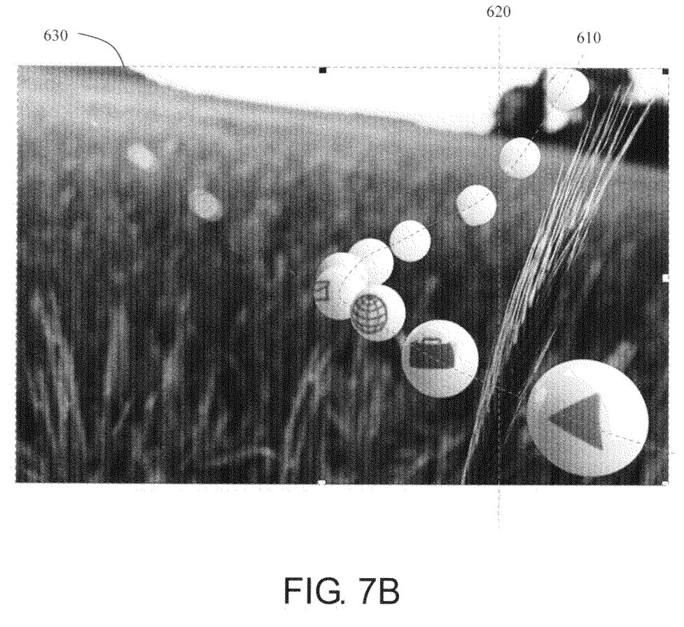

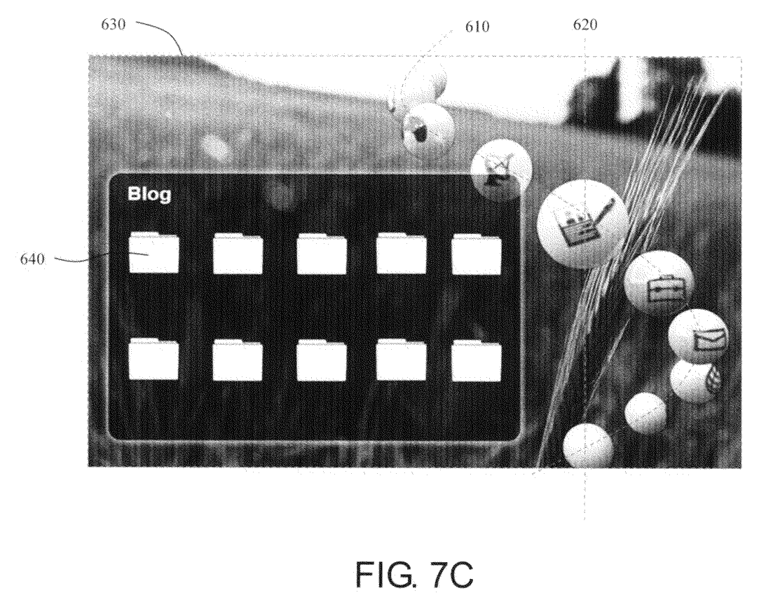

For example, FIGS. 7A, 7B, and 7C are examples illustrating a method for operating a space menu according to one embodiment of the present invention. Referring to FIG. 6 first, the item balls respectively representing functions of multimedia playback, business, internet, electronic mail, office, calendar, GPS, game, return and tools are displayed along a spiral path having a central axis perpendicular to a normal direction of a display plane of the screen.

Referring to FIG. 7A, when a user touches on the space menu and drags through the item ball that represents the multimedia playback function, the item balls are rotated along the spiral path in a counter clockwise direction by a rotation angle, in which the designated item ball is enlarged and moved to the front such that the relative distance between the pointed item object and the display plane of the screen is the shortest and the designated item ball can be protruded from the others.

On the other hand, referring to FIG. 7B, when the user touches on the space menu and drags through the item ball that represents the tools function, the item balls are rotated in a clockwise direction by a rotation angle. Similarly, the designated item ball is enlarged and moved to the front such that the relative distance between the pointed item object and the display plane of the screen is the shortest and the designated item ball can be protruded from the others.

Moreover, referring to FIG. 7C, when the user directly touches on the item ball that represents the business function, since the designated item ball is in the front of the space menu, the space menu is not rotated. However, the designated item ball is still enlarged so as to be protruded from the others. Meanwhile, the business function is executed and a plurality of business files are displayed on the left side the space menu such that the user to browse and manage those business files.

According to the above method, the present invention provides another pattern of the space menu for the user to browse and select item objects. Similarly, each of the item objects are corresponding to a specific area, the user may simply drag through or directly touch the specific area to operate the space menu. The redundant operation is reduced and the convenience is increased.

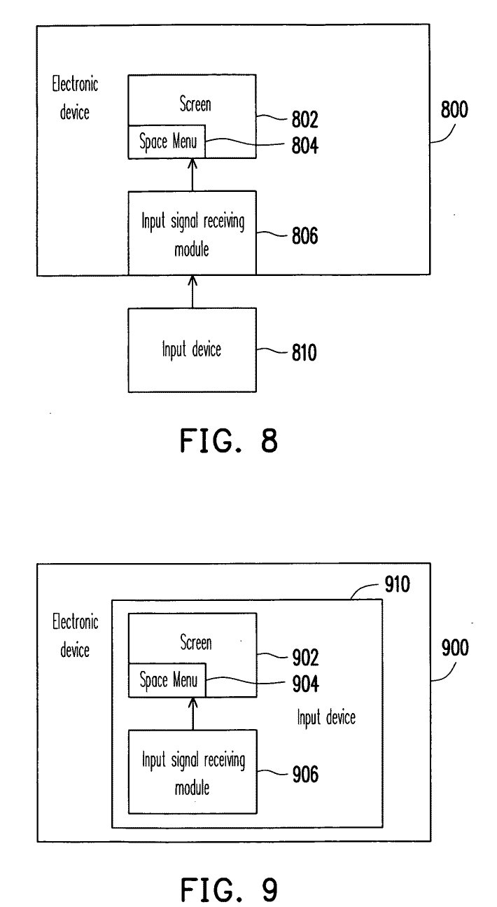

Based on the above method for operating a space menu, the space menu can be display on a screen of an electronic device and used for operating functions of the electronic device. FIG. 8 is a block diagram illustrating an electronic device with an operating space menu according to one embodiment of the present invention. Referring to FIG. 8, the electronic device 800 comprises a screen 802, a space menu 804 and an input signal receiving module 806, and the functions thereof are described in the following.

The screen 802 is a screen of a cathode ray tube (CRT) or a liquid crystal display (LCD), and used for displaying a frame of the electronic device 800.

The space menu 804 is displayed on the screen 802 and comprises a plurality of item objects. In one embodiment, the item objects can be sequentially displayed along a linear path on a menu plane, in which the menu plane may not be parallel to the display plane so that the item objects are visually arranged in a three-dimensional space instead of being arranged on a two-dimensional display plane. In another embodiment, the item objects can be sequentially displayed along a spiral path, in which a central axis of the spiral path is not parallel to a normal direction of a display plane of the screen. The two kinds of space menus are described in the aforesaid embodiments, such that the related details are not repeated herein again.

The input signal receiving module 806 receives an operation of a user for the space menu 804 from an input device 810, so as to operate the space menu 804, in which the input device 810 can be mouse, keyboard, touch panel, or touch screen. To be specific, for the space menu 804 having item objects sequentially displayed along a linear path on a menu plane, the item objects of the space menu 804 are rotated on the menu plane about a rotation axis according to a position of the item object pointed by the operation, in which a direction of the rotation axis is not parallel to a normal direction of a display plane of the screen. On the other hand, for the space menu 804 having item objects sequentially displayed along a spiral path, the item objects are rotated on the spiral path about the central axis according to a position of the item object pointed by the operation and a central axis of the spiral path is not parallel to a normal direction of a display plane of the screen.

It should be noted herein that, in another embodiment, the input device and the screen can be integrated into a touch screen, so as to provide users with an intuitive way to operate the space menu. FIG. 9 is a block diagram illustrating an electronic device with an operating space menu according to one embodiment of the present invention. Referring to FIG. 9, the electronic device 900 comprises an input device 910 and the input device 910 further comprises a screen 902, a space menu 904 and an input signal receiving module 906, and the functions thereof are described in the following.

The screen 902 is a screen of a liquid crystal display used for displaying a frame of the electronic device 900. The input signal receiving module 906 is a touch panel used for receiving an operation of a user for the space menu 904, so as to operate the space menu 904. The screen 902 and the input signal receiving module 906 are integrated as a touch screen, such that the user can operate the space menu 904 displayed on the screen 902 by directly touching the screen 902.

The space menu 904 comprises a plurality of item objects and those item objects can be sequentially displayed along a linear path on a menu plane or sequentially displayed along a spiral path. The operation for these two kinds of space menus are described in the aforesaid embodiments, such that the related details are not repeated herein again.

To sum up, the present invention provides a method for operating a space menu and an electronic device with an operating space menu, in which a plurality of item objects are arranged along a linear path or a spiral path so as to provide an intuitive space menu representing the functions of the electronic device. Moreover, the operations of a user are classified into pointing operations and selecting operations and used for rotating the item objects or executing functions. Accordingly, a more intuitive and convenient way for operating a menu is provided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating a space menu, suitable for an electronic device having a screen, the method comprising:
sequentially displaying a plurality of item objects along a linear path on a menu plane to generate said space menu;
receiving an operation of a user for the space menu;
rotating the item objects on the menu plane about a rotation axis according to a position of the item object pointed by the operation, wherein a direction of the rotation axis is not parallel to a normal direction of a display plane of the screen; and
executing an item function according to the item object selected by the operation.

2. The method for operating a space menu according to claim 1, wherein the operation of the user for the space menu comprises using an input device to move around the space menu or select one of the item objects.

3. The method for operating a space menu according to claim 2, wherein the input device comprises mouse, keyboard, touch panel, or touch screen.

4. The method for operating a space menu according to claim 1, wherein the direction of the rotation axis is perpendicular to a direction of the linear path.

5. The method for operating a space menu according to claim 1, wherein the step of rotating the item objects on the menu plane about the rotation axis according to the position of the item object pointed by the operation comprises:
calculating a rotation angle for rotating the menu plane according to a distance between the pointed item object and the rotation axis;
determining to rotate the menu plane in a clockwise direction or in a counterclockwise direction according to a relative position of the pointed item object corresponding to the rotation axis; and
rotating the item objects on the menu plane about the rotation axis to the determined direction by the rotation angle.

6. The method for operating a space menu according to claim 5, wherein the step of rotating the item objects on the menu plane about the rotation axis according to the position of the item object pointed by the operation further comprises:
zooming the item objects on the menu plane so as to be covered by the display plane of the screen according to the rotation angle and the relative position and distance between each of the item objects and the rotation axis.

7. The method for operating a space menu according to claim 4, wherein the rotation axis comprises passing through a geometric center of the item objects.

8. The method for operating a space menu according to claim 1, wherein after the step of rotating the item objects on the menu plane about the rotation axis according to the position of the item object pointed by the operation, the method further comprises:
enlarging the item object pointed by the operation so as to protrude the pointed item object from the other item objects.

9. The method for operating a space menu according to claim 1, wherein after the step of rotating the item objects on the menu plane about the rotation axis according to the position of the item object pointed by the operation, the method further comprises:
moving the item object pointed by the operation toward a normal direction of the menu plane by a preset length so as to protrude the item object from the other item objects.

10. The method for operating a space menu according to claim 1, wherein the step of sequentially displaying the item objects along a linear path on the menu plane further comprises:
displaying an item icon on a surface of each item object facing a normal direction of the menu plane.

11. A method for operating a space menu, suitable for an electronic device having a screen, the method comprising:
sequentially displaying a plurality of item objects along a spiral path to generate said space menu, wherein a central axis of the spiral path is not parallel to a normal direction of a display plane of the screen;
receiving an operation of a user for the space menu;
rotating the item objects on the spiral path about the central axis according to a position of the item object pointed by the operation; and
executing an item function according to the item object selected by the operation.

12. The method for operating a space menu according to claim 11, wherein the step of sequentially displaying the item objects along the spiral path to generate the space menu comprises:
zooming the item objects according to a relative distance between each of the item objects and the display plane of the screen.

13. The method for operating a space menu according to claim 12, wherein the step of rotating the item objects on the spiral path about the central axis according to the position of the item object pointed by the operation comprises:
rotating the item objects on the spiral path about the central axis such that the relative distance between the pointed item object and the display plane of the screen is the shortest.

14. The method for operating a space menu according to claim 11, wherein the operation of the user for the space menu comprises using an input device to move around the space menu or select one of the item objects.

15. The method for operating a space menu according to claim 14, wherein the input device comprises mouse, keyboard, touch panel, or touch screen.

16. The method for operating a space menu according to claim 11, wherein a position of each item object projected on the central axis remains unchanged when the item objects on the spiral path are rotated about the central axis.

17. The method for operating a space menu according to claim 16, wherein the step of rotating the item objects on the spiral path about the central axis according to the position of the item object pointed by the operation comprises:
calculating a rotation angle for rotating the item objects on the spiral path according to the relative distance between the pointed item object and the display plane of the screen; and
determining to rotate the item objects on the spiral path in a clockwise direction or in a counterclockwise direction according to a relative position of the pointed item object on the spiral path; and
rotating the item objects on the spiral path about the central axis to the determined direction by the rotation angle.

18. The method for operating a space menu according to claim 16, wherein the step of rotating the item objects on the spiral path about the central axis according to a position of the item object pointed by the operation further comprises:
zooming the item objects according to a relative distance between each of the item objects and the display plane of the screen after the item objects are rotated.

19. The method for operating a space menu according to claim 11, wherein after the step of rotating the item objects on the spiral path about the central axis according to a position of the item object pointed by the operation, the method further comprises:
enlarging the item object pointed by the operation so as to protrude the pointed item object from the other item objects.

20. The method for operating a space menu according to claim 11, wherein the step of sequentially displaying the item objects along the spiral path to generate the space menu comprises:
displaying an item icon on a surface of each item object facing a normal direction from the central axis of the spiral path to the item object.

21. An electronic device with an operating space menu, comprising:
a screen;
a space menu, comprising a plurality of item objects and being displayed on said screen, wherein said plurality of item objects are arranged sequentially along a linear path on a menu plane; and
an input signal receiving module, receiving an operation of a user for the space menu, wherein the item objects are rotated on the menu plane about a rotation axis according to a position of the item object pointed by the operation and a direction of the rotation axis is not parallel to a normal direction of a display plane of the screen.

22. The electronic device with an operating space menu according to claim 21, wherein an item function is executed according to the item object selected by the operation.

23. The electronic device with an operating space menu according to claim 21, wherein the operation of the user for the space menu comprises using an input device to move around the space menu or select one of the item objects.

24. The electronic device with an operating space menu according to claim 23, wherein the input device comprises mouse, keyboard, touch panel, or touch screen.

25. The electronic device with an operating space menu according to claim 21, wherein the direction of the rotation axis is perpendicular to a direction of the linear path.

26. The electronic device with an operating space menu according to claim 21, wherein the method of rotating the item objects on the menu plane about the rotation axis according to the position of the item object pointed by the operation comprises:
calculating a rotation angle for rotating the menu plane according to a distance between the pointed item object and the rotation axis;
determining to rotate the menu plane in a clockwise direction or in a counter clockwise direction according to a relative position of the pointed item object corresponding to the rotation axis; and
rotating the item objects on the menu plane about the rotation axis to the determined direction by the rotation angle.

27. The electronic device with an operating space menu according to claim 26, wherein the method of rotating the item objects on the menu plane about the rotation axis according to the position of the item object pointed by the operation further comprises:
zooming the item objects on the menu plane so as to be covered by the display plane of the screen according to the rotation angle and the relative position and distance between each of the item objects and the rotation axis.

28. The electronic device with an operating space menu according to claim 25, wherein the rotation axis comprises passing through a geometric center of the item objects.

29. The electronic device with an operating space menu according to claim 21, wherein the item object pointed by the operation is enlarged so as to protrude the pointed item object from the other item objects after the item objects are rotated on the menu plane.

30. The electronic device with an operating space menu according to claim 21, wherein the item object pointed by the operation is moved toward a normal direction of the menu plane by a preset length so as to protrude the item object from the other item objects after the item objects are rotated on the menu plane.

31. The electronic device with an operating space menu according to claim 21, wherein an item icon is displayed on a surface of each item object facing a normal direction of the menu plane after the item objects are displayed sequentially along a linear path on the menu plane.

32. An electronic device with an operating space menu, comprising:
a screen;
a space menu, comprising a plurality of item objects and being displayed on said screen, wherein said plurality of item objects are arranged sequentially along a spiral path on a menu plane; and
an input signal receiving module, receiving an operation of a user for the space menu, wherein the item objects are rotated on the spiral path about the central axis according to a position of the item object pointed by the operation and a central axis of the spiral path is not parallel to a normal direction of a display plane of the screen.

33. The electronic device with an operating space menu according to claim 32, wherein an item function is executed according to the item object selected by the operation.

34. The electronic device with an operating space menu according to claim 32, wherein the operation of the user for the space menu comprises using an input device to move around the space menu or select one of the item objects.

35. The electronic device with an operating space menu according to claim 34, wherein the input device comprises mouse, keyboard, touch panel, or touch screen.

36. The electronic device with an operating space menu according to claim 32, wherein the method of sequentially displaying the item objects along the spiral path to generate the space menu comprises:
zooming the item objects according to a relative distance between each of the item objects and the display plane of the screen.

37. The electronic device with an operating space menu according to claim 36, wherein the step of rotating the item objects on the spiral path about the central axis according to the position of the item object pointed by the operation comprises:
rotating the item objects on the spiral path about the central axis such that the relative distance between the pointed item object and the display plane of the screen is the shortest.

38. The electronic device with an operating space menu according to claim 32, wherein a position of each item object projected on the central axis remains unchanged when the item objects on the spiral path are rotated about the central axis.

39. The electronic device with an operating space menu according to claim 38, wherein the method of rotating the item objects on the spiral path about the central axis according to the position of the item object pointed by the operation comprises:
calculating a rotation angle for rotating the item objects on the spiral path according to the relative distance between the pointed item object and the display plane of the screen; and
determining to rotate the item objects on the spiral path in a clockwise direction or in a counter clockwise direction according to a relative position of the pointed item object on the spiral path; and
rotating the item objects on the spiral path about the central axis to the determined direction by the rotation angle.

40. The electronic device with an operating space menu according to claim 38, wherein the method of rotating the item objects on the spiral path about the central axis according to a position of the item object pointed by the operation comprises:
zooming the item objects according to a relative distance between each of the item objects and the display plane of the screen after the item objects are rotated.

41. The electronic device with an operating space menu according to claim 32, wherein the item object pointed by the operation is enlarged so as to protrude the pointed item object from the other item objects after the item objects are rotated on the spiral path.

42. The electronic device with an operating space menu according to claim 32, wherein an item icon is displayed on a surface of each item object facing a normal direction from the central axis of the spiral path to the item object after the item objects are displayed sequentially along the spiral path to generate the space menu.
